(19) United States
(12) Patent Application Publication
(10) Pub. No.: US 2012/0075398 A1
(43) Pub. Date: Mar. 29, 2012

(54) PORTABLE ELECTRONIC DEVICE AND METHOD OF CONTROLLING THE ELECTRONIC DEVICE TO OUTPUT INFORMATION

(75) Inventors: Jason Tyler GRIFFIN, Kitchener (CA); Clara GAGGERO, London (GB)

(73) Assignee: Research In Motion Limited, Waterloo (CA)

(21) Appl. No.: 12/892,389

(22) Filed: Sep. 28, 2010

(51) Int. Cl. B41J 2/00

(52) U.S. Cl. 347/110

(57) ABSTRACT

A portable electronic device includes a device configured to detect an event, a marker configured to mark a surface that is separate from the portable electronic device, and at least one actuator arranged to configure the marker to apply the mark in response to the event.

### FIELD OF TECHNOLOGY

The present disclosure relates to electronic devices including but not limited to portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones, wireless PDAs, and laptop computers with wireless 702.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. Improvements in devices with touch-sensitive displays are desirable.

### BRIEF DESCRIPTION OF THE DRAWINGS

FIG. 1 is a block diagram of a portable electronic device in accordance with the present disclosure.

FIG. 2 is a front view of an example of a portable electronic device including a marker in accordance with the disclosure.

FIG. 3 is a partial cross-section of an actuator and marker of the portable electronic device in accordance with the disclosure.

FIG. 4 illustrates a portable electronic device including a marker and a user touching the marker in accordance with the disclosure.

FIG. 5 illustrates a mark on a thumb of a user in accordance with the disclosure.

FIG. 6 is a flowchart illustrating a method of controlling the electronic device output information in accordance with the disclosure.

FIG. 7 is a view of another example of a portable electronic in accordance with the disclosure.

FIG. 8 a front view of another example of a portable electronic in accordance with the disclosure.

### DETAILED DESCRIPTION

The following describes an electronic device that includes a device configured to detect an event, a marker configured to mark a surface that is separate from the portable electronic device, and at least one actuator arranged to configure the marker to apply the mark in response to the event. A method includes detecting an event, determining a response to the event, and actuating one or more actuators to configure a marker to apply a mark based on the response.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, which is a portable electronic device in the embodiments described herein. Examples of portable electronic devices include mobile, or handheld, wireless communication devices such as pagers, cellular phones, cellular smart-phones, wireless organizers, personal digital assistants, wirelessly enabled notebook computers, tablet computers, and so forth. The portable electronic device may also be a portable electronic device without wireless communication capabilities, such as a handheld electronic game device, digital photograph album, digital camera, or other device.

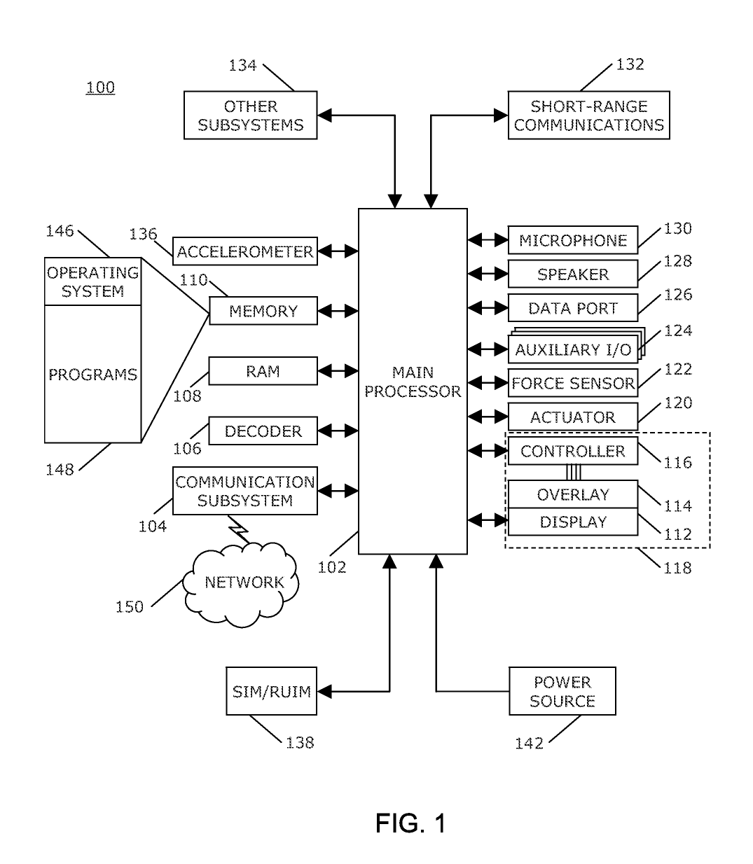

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with a touch-sensitive overlay 114 operably connected to an electronic controller 116 that together comprise a touch-sensitive display 118, one or more actuators 120, one or more force sensors 122, an auxiliary input/output (I/O) subsystem 124, a data port 126, a speaker 128, a microphone 130, short-range communications 132, and other device subsystems 134. User-interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal, such as a text message, an e-mail message, or web page download, is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display includes a capacitive touch-sensitive overlay 114. The overlay 114 may be an assembly of multiple layers in a stack which may include, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive display 118. The processor 102 may determine attributes of the touch, including a location of a touch. Touch location data may include an area of contact or a single point of contact, such as a point at or near a center of the area of contact. A signal is provided to the controller 116 in response to detection of a touch. A touch may be detected from any suitable object, such as a finger, thumb, appendage, or other items, for example, a stylus, pen, or other pointer, depending on the nature of the touch-sensitive display 118. The controller 116 and/or the processor 102 may detect a touch by any suitable contact member on the touch-sensitive display 118. Multiple simultaneous touches may be detected.

One or more gestures may also be detected by the touch-sensitive display 118. A gesture, such as a swipe, also known as a flick, is a type of touch that begins at an origin point and continues to a finishing point on the touch-sensitive display 118. A gesture may be identified by attributes of the gesture, including the start point, the end point, the distance travelled, the duration, and the direction, for example. A gesture may be long or short in distance and/or duration. Two points of the gesture may be utilized to determine a direction of the gesture.

An optional force sensor 122 or force sensors may be disposed in any suitable location, for example, between the touch-sensitive display 118 and a back of the portable electronic device 100 to detect a force imparted by a touch on the touch-sensitive display 118. The force sensor 122 may be a force-sensitive resistor, strain gauge, piezoelectric or piezoresistive device, pressure sensor, or other suitable device. Force as utilized throughout the specification refers to force measurements, estimates, and/or calculations, such as pressure, deformation, stress, strain, force density, force-area relationships, thrust, torque, and other effects that include force or related quantities.

Force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

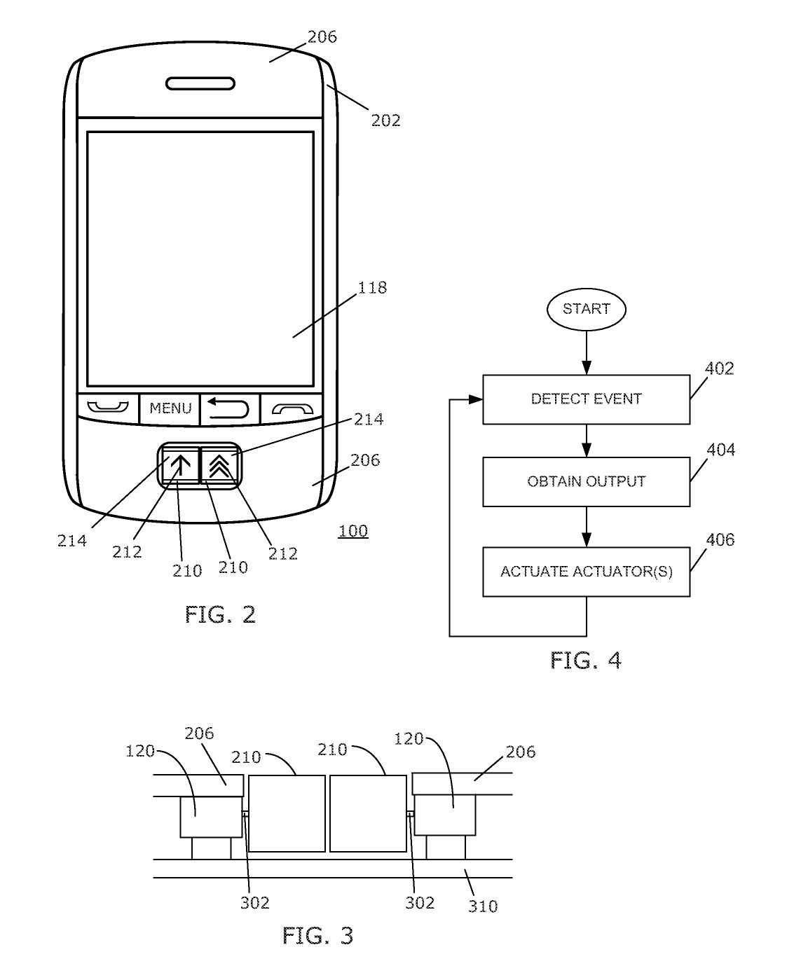

Views of an example of the portable electronic device 100 are shown in FIG. 2 and FIG. 3. The portable electronic device 100 includes a housing 202 that encloses components such as shown in FIG. 1. The housing 202 may include a back 204, sidewalls (not shown), and a front 206 of the housing. The front 206 of the housing includes openings through which the touch-sensitive display 118 and the markers 210 are accessible. The markers 210 may be accessible anywhere along any part of the housing 202.

A partial cross section of the portable electronic device 100 through the center of the actuators 120 and the markers 210 is shown in FIG. 3. In this example, two actuators 120 are utilized to position two markers 210 to mark a surface that is separate from the portable electronic device 100. The surface may be a part of a person, such as a finger or other part of a hand, or an inanimate object, such as a glove, piece of paper, plastic, or other impressionable material, or other suitable object. The actuators 120 position the markers 210 in response to an event at the portable electronic device. The actuators 120 may be, for example, miniature stepper motors that are utilized to guide or index the markers 210 to a position to output information based on the event. The actuator(s) 120 are not limited to miniature stepper motors and any suitable actuators may be utilized. The actuator or actuators utilized are advantageously selected to operate with the marker.

The markers 210 may be any suitable device for marking a surface. In the example illustrated in FIG. 2 and FIG. 3, the markers 210 are rotatable cubes or cylinders with rounded edges. The markers 210 are rotatable, for example, on an axle 302 extending from the actuators 120. Each marker 210 may be rotated into any one of multiple positions such that any of a plurality of marking elements 212 is accessible, e.g., through the opening in the front 206 of the housing 202. The marking elements 212, which provide information in the form of symbols and/or characters, protrude from the markers 210. In the example where the marker 210 is a cube, each of four faces 214 of the cube may include a marking element 212 that protrudes from the face. Each face 214 may include a single protruding marking element 212 or may include multiple protruding marking elements 212 to output information to the user.

The marking elements may be associated with a single application on the portable electronic device 100 or may be associated and utilized with multiple applications on the electronic device 100. For the purpose of the example shown in FIG. 2, the marking elements 306 are associated with a navigation application running on the portable electronic device 100. A user may wish to obtain directions to a destination. The destination may be entered, for example, utilizing the touch-sensitive display 118. The portable electronic device 100, when running the navigation application, may determine the location of the portable electronic device 100 and provide directions to the destination. The directions may be provided utilizing the touch-sensitive display 118 and/or the markers 210.

A flowchart illustrating a method of controlling an electronic device, such as the portable electronic device 100, is shown in FIG. 4. The method may be carried out by computer-readable code executed, for example, by the processor 102. Coding of software for carrying out such a method is within the scope of a person of ordinary skill in the art given the present description. The method may contain additional or fewer processes than shown and/or described, and may be performed in a different order.

The method may be carried out in any suitable application that outputs information, for example, an email application, a text messaging application, a calendar application, a tasks application, an address book application, a navigation application, and so forth. An event is detected 402. The event may be, for example, an input that is detected and determined to be a query, such as a query input detected through a navigation device. The event may be an input through a navigation device of the portable electronic device 100. The input may be provided via any suitable input from one or more navigation devices. For example, the navigation device may be the touch-sensitive display 118, a trackpad, a trackball, a scroll wheel, an optical joystick, or any other suitable navigation device. The input may be a gesture on the navigation device, depression of the navigation device, or a force applied to a navigation device, and so forth.

The input may be identified as a query, for example, when the input is associated with a query based on the attributes of the input. For example, attributes for a gesture may be utilized to match the gesture to a query. These attributes may include shape, direction, duration, distance, length, start location, end location, and so forth. Alternatively, a force value that meets a threshold may be matched to a query.

Alternatively, the event may be a phone call, receipt of an email, determination of a position utilizing, for example, a navigation application, time, a period of time, or any other suitable event. The output provided may be caller identification, email sender, time period, and so forth.

A response to the event is obtained 404. The response may be obtained based on information identified by, obtained by, for example, via the network 150, and/or stored in the portable electronic device 100 the portable electronic device 100.

The marker(s) is/are positioned to provide output in response to the event at 406. The output is provided by actuating the actuators 120 to position the markers. After applying the gesture to the portable electronic device 100, the user may place a surface, such as a part of the hand or piece of paper against the markers. The mark is applied by pressure applied by the markers 210 against the surface, by the user pressing the surface against the markers 210, or both.

The markers may remain in position for a predetermined period of time, for example, after the event is detected, or the position of the markers may be maintained until a further event is detected.

For example, the markers may be utilized to provide directions to a destination when a query is detected by the portable electronic device 100, e.g., in circumstances in which a user does not wish to remove the portable electronic device 100 from a location such as a holster, pocket, or purse.

In one example, a destination is entered in a navigation application. The portable electronic device 100 may be placed, for example, in a pocket or purse. When an event is detected, such as reaching a location where a turn is indicated by the navigation application or when the user checks the directions, an output is provided. Input, such as a swipe or other gesture, may be detected utilizing the touch-sensitive display 118 to provide an update or check of directions to the user.

When a gesture is detected on the touch-sensitive display 118, the gesture is identified as a query, based on the gesture attributes, such as start location, direction, distance, duration, shape, finish location, and so forth. When the gesture is determined to be associated with a query, a response, which in this example includes directions, is obtained. The response may be based on the location of the portable electronic device 100 when the event is detected. The response may also be based on the destination location. The response may be obtained based on a short history of movement. For example, when the location of the portable electronic device 100 is determined to be an intersection of roads, a short history of movement may be utilized to determine the direction of travel. Alternatively, the portable electronic device 100 may await further movement to determine the direction of travel. The actuators 120 are actuated to position the markers to provide output in response to the query.

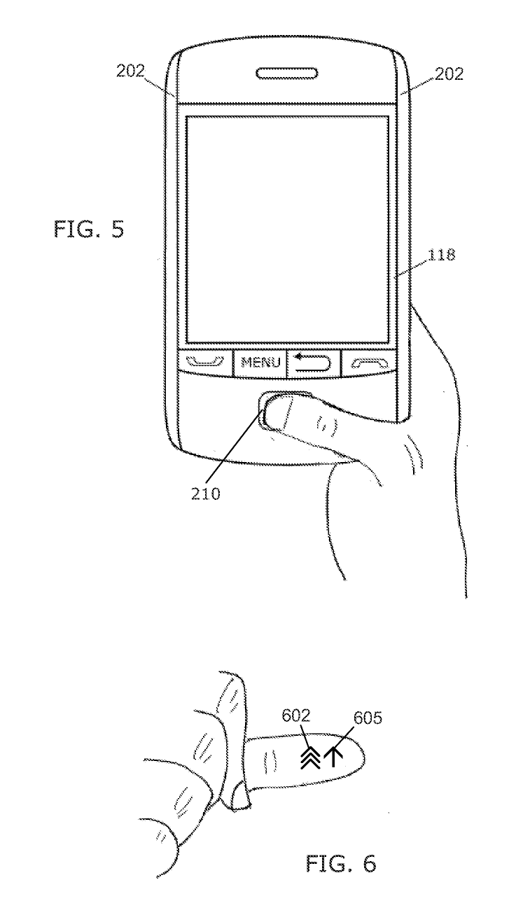

An example of a user placing a thumb on the markers 210 of the portable electronic device 100 is illustrated in FIG. 5, and a mark on the thumb of the user is illustrated in FIG. 6. After applying the gesture to the portable electronic device 100, the user places a thumb on the markers. The markers 210 imprint or indent the surface of the thumb. The user views the thumb to view the directions. In the example shown in FIG. 6, the directions may indicate to the user that the destination is far ahead, as illustrated by the three has marks, and to continue straight, as indicated by the straight arrow. Other marking elements may be included, for example to indicate to the user that the destination is near, that the user has arrived, to turn right, turn left, turn around, and so forth.

The marking elements 212 are mirror images of the imprinted directions on the thumb, as illustrated in FIG. 2 and FIG. 5. The indent on the surface, such as a thumb, may be temporary when the surface comprises a viscoelastic material, e.g., a surface that recovers from the indent within a short period of time.

An alternative example of markers of a portable electronic device 100 is illustrated in FIG. 7. In the example illustrated in FIG. 7, two markers 702, 704 in the form of rotating discs are utilized. In this example, a part of each marker 702, 704 is accessible through the opening in the front of the housing. The outline of each marker 702, 704 is illustrated by dashed lines. Each marker includes a plurality of marking elements 706, 708. Two actuators, which may be, for example, miniature stepper motors, are utilized to rotate the markers 702, 704 to provide access to one or more marking elements 706, 708 based on the information requested or the event that initiated the markers 702, 704 to provide information. The marking elements 706, 708 on each disc may be spaced apart such that a single marking element 706, 708 is accessible through the opening in the front of the housing at any one instance in time. Alternatively, the marking element may contain a blank or null element that leaves no impression. The marking elements 706, 708 illustrated in FIG. 7 may be associated with a calendar or clock application on the portable electronic device, for example, to indicate time remaining until a next calendared event or to tell the time of day. The marker 702 may include marking elements indicating units, such as M for minutes, H for hours, and D for days. The marker 704 may include marking elements indicating numbers such as 10, 30, 1, and so forth.

In one example, an event is detected, such as a force imparted on the touch-sensitive display 118. A response may be based on the time when the event is detected and the next scheduled calendared event. The time may be rounded to a nearest number for which a corresponding marking element exists. The marking elements 706, 708 are shown as mirror images of the imprinted time and, in the example shown in FIG. 7, time intervals are 10 minute periods of time.

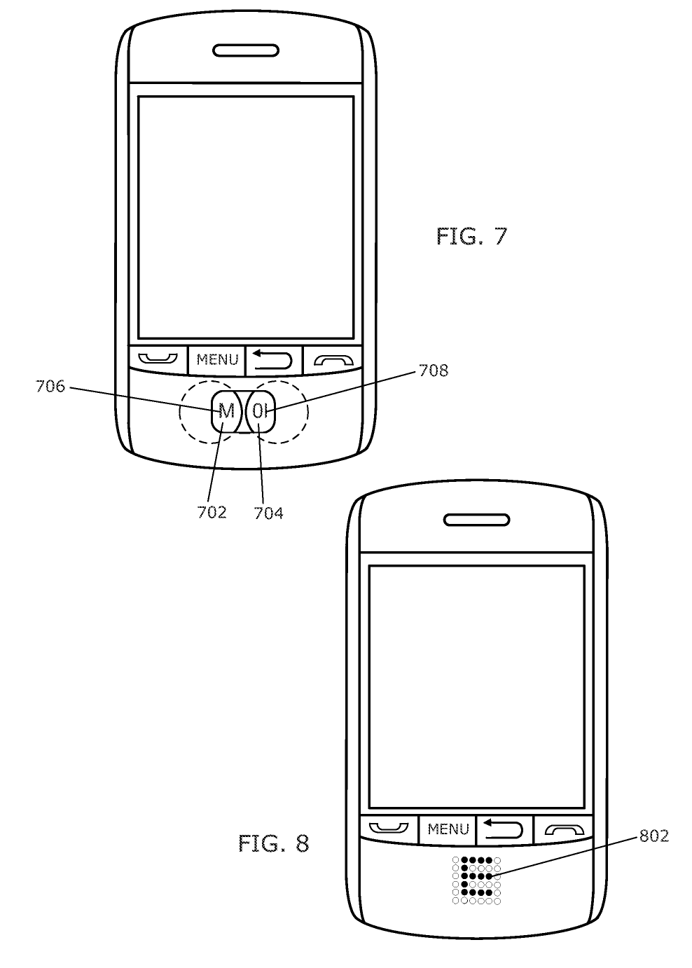

Another example of markers of a portable electronic device 100 is illustrated in FIG. 8. Markers 802 in the form of pins are located at least partially in one or more holes and are actuated by respective actuators to protrude from each other. In one example, only the markers 802 that provide the information protrude through the holes, and the remaining markers do not protrude through the holes. The markers 802 that provide the information may simply protrude beyond the markers 802 that do not provide the information. In the example illustrated in FIG. 8, 36 markers 802 are utilized in a 6 by 6 matrix of closely spaced pins. Any suitable number or arrangement of markers 802 may be utilized. The markers 802 may be extended for example, by actuating piezoelectric actuators to cause the markers to protrude from the holes. The information provided by the markers 802 may be associated with any suitable application. In the example of FIG. 8, protruding pins are illustrated by solid or black holes. A mirror image of 3 is shown, which may represent a time of 3:00, 3 unread emails, 3 time intervals to a next meeting, and so forth, depending on the application. The detected event may be a circular gesture on the touch-sensitive display 118, which is associated with a query such as the current time or unread emails. Actuators are actuated such that the appropriate markers 802 protrude to mark the “3” on the surface provided.

In the above examples, the event that is detected is an input provided through a user interface. Other events may be detected, such as arrival at or near a location, as determined utilizing the navigation application, passage of a period of time, an incoming phone call or email, or other event that is detected without user interaction or query.

The markers may be utilized to apply a mark by indenting or imprinting a surface. Alternatively, the markers may apply a material such as a liquid, e.g., disappearing ink, water-soluble dye, and so forth to surface that is separate from the portable electronic device. For example, the rotatable markers of FIG. 2 and FIG. 7 may be rotated across an ink pad such that ink is applied to the marking elements, which ink may be transferred to the surface.

Optionally, a cover may extend over the marker and/or the opening in the housing through which the marker is accessible. The cover may be opened by moving the cover, for example, by sliding or rotating the cover. The marker may optionally be a peripheral device to the portable electronic device. The information may appear on the markers as a mirror or reverse image such that the imprint on the surface is readable by a user. The marking elements may be associated with one or more applications. The actuators may be piezoelectric, magnetic, motorized, and so forth.

The portable electronic device 100 is not limited to the portable electronic device shown and described with reference to FIG. 1. Other portable electronic devices may be utilized. For example, a peripheral device with the markers may communicate with the portable electronic device via short-range communication. The portable electronic device need not include a communication subsystem nor communicate with a network.

Circumstances may arise in which a user may wish to obtain information from a portable electronic device without retrieving the device and viewing. In such circumstances, viewing an electronic device may be considered rude, interruptive, or may be unsafe. The portable electronic device applies or transfers a mark to an external surface, such as part of a hand or an inanimate object, facilitates output of information without the need for the user to look at the device or remove it from a holster, pocket, or other storage location.

A portable electronic device includes a device configured to detect an event, a marker configured to mark a surface that is separate from the portable electronic device, and at least one actuator arranged to configure the marker to apply the mark in response to the event. A method includes detecting an event, determining a response to the event, and actuating one or more actuators to configure a marker to apply a mark based on the response.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A portable electronic device comprising:
a device configured to detect an event;
a marker configured to mark a surface that is separate from the portable electronic device;
at least one actuator arranged to configure the marker to apply the mark in response to the event.

2. The portable electronic device according to claim 1, wherein the device comprises at least one of a touch-sensitive display, a trackpad, a trackball, a scroll wheel, and an optical joystick.

3. The portable electronic device according to claim 1, wherein the mark comprises information relating to an application on the portable electronic device.

4. The portable electronic device according to claim 1, wherein the mark is applied by indenting the surface.

5. The portable electronic device according to claim 1, wherein the mark comprises an ink mark.

6. The portable electronic device according to claim 1, wherein the marker is arranged to mark skin of a user.

7. The portable electronic device according to claim 1, wherein the marker includes a mirror image of the mark.

8. The portable electronic device according to claim 1, wherein the event comprises a query.

9. The portable electronic device according to claim 1, wherein the event comprises a gesture.

10. The portable electronic device according to claim 1, wherein the device comprises a force sensor and the event comprises a force imparted on the force sensor.

11. The portable electronic device according to claim 1, wherein the marker comprises a rotary element that includes a plurality of marking elements.

12. The portable electronic device according to claim 11, wherein the marking elements form symbols.

13. The portable electronic device according to claim 11, wherein the actuator rotates the rotary element.

14. The portable electronic device according to claim 11, wherein the actuator positions at least one marking element of the marker.

15. The portable electronic device according to claim 1, wherein the marker comprises a plurality of movable pins that protrude to form a shape on the surface.

16. The portable electronic device according to claim 15, wherein the at least one actuator comprises a plurality of piezoelectric actuators.

17. A method comprising:
detecting an event;
determining a response to the event;
actuating one or more actuators to configure a marker to apply a mark based on the response.

18. The method according to claim 17, further wherein detecting the event comprises detecting a gesture on the navigation device an electronic device and identifying the gesture as the query.

19. The method according to claim 17, wherein detecting comprises detecting an imparted force on an input device and determining that the force meets a threshold.

20. The method according to claim 17, wherein determining the response comprises determining which of the actuators to actuate.

21. The method according to claim 17, wherein the actuators move a plurality of pins, and actuating a first actuator comprises causing one of the plurality of pins to protrude.

22. The method according to claim 17, wherein the mark is applied to a surface separate from the portable electronic device.
